(19) United States
(12) Patent Application Publication
(10) Pub. No.: US 2015/0166840 A1
(43) Pub. Date: Jun. 18, 2015

(54) GLOSS ENHANCING AND STAINLESS STEEL POLISH COMPOSITIONS

(71) Applicant: WACKER CHEMICAL CORPORATION, Adrian, MI (US)

(72) Inventor: Michael Lee COFFEY, Adrian, MI (US)

(21) Appl. No.: 14/547,486

(22) Filed: Nov. 19, 2014

Related U.S. Application Data
(63) Continuation-in-part of application No. 14/105,254, filed on Dec. 13, 2013.

(51) Int. Cl. C09G 1/12; C23C 26/00; C09G 1/04

(52) U.S. Cl. CPC C09G 1/12; C09G 1/04; C23C 26/00

(57) ABSTRACT

Gloss enhancing compositions for polymer surfaces and polishing compositions for stainless steel surfaces are microemulsions of a diaminoorganopolysiloxane, a film forming acrylate polymer, and a wax. The compositions exhibit high gloss, low sling off, and high durability, and can be formulated without organic solvents.

### CROSS-REFERENCE TO RELATED APPLICATIONS

This application is a continuation-in-part of U.S. application Ser. No. 14/105,254 filed Dec. 13, 2013, now pending, the disclosure of which is hereby incorporated in its entirety by reference herein.

### BACKGROUND OF THE INVENTION

1. Field of the Invention

The invention pertains to aqueous formulations suitable as polymer dressing formulations, particularly in the automotive sector, which provide dry, sling-free, and glossy surfaces on polymer articles such as rubber and vinyl polymers, containing each of a wax dispersion, an acrylate polymer, and a “diamino” polysiloxane fluid. The compositions surprisingly also provide an excellent stainless steel polish.

2. Description of the Related Art

Most polymers used for aesthetic or utilitarian purposes suffer from loss of initial gloss over time. In the automotive sector, examples include tires, unpainted exterior components such as bumper guards, wheel well trim, and interior components such as upholstery, bolsters, dashboards, and the like.

For example, with respect to tires, natural oxidation as well as microabrasion by fine particles soon dulls the tire's exterior. It is common, now, to “dress” the tires with a gloss formulation or “tire shine” to restore all or a part of the original appearance, and in many cases, to impart a level of gloss higher than the original.

In like manner, internal and external polymer components also lose their gloss over time. In both instances, some loss of gloss may be due to loss of plasticizer. Whatever the reason, a large market exists for preparations which can improve the aesthetics of tires, upholstery, and the like.

Commercial tire dressings are predominately solvent based. Two problems with solvent borne systems are that first, the vast majority of useable solvents add considerable amounts of environmentally undesirable volatile organic compounds (VOC) to the environment. A second problem is that organic solvents may leach organic pigments, plasticizers, organic antioxidants, etc., from the surface to which they are applied. Hence, it would be desirable to formulate without the use of organic solvents entirely. However, since low viscosity, sprayable compositions are desired, the only real alternative is to formulate the dressing, etc., as an aqueous dispersion or emulsion. However, even when formulated as an aqueous emulsion, such formulations have required the use of organic solvent in the dispersed phase, and thus while the total amount of solvent is decreased, it is not eliminated.

Acceptable systems must also exhibit durability, in particular when exposed surfaces are involved, such as in tire dressings. Attempts to produce fully organopolysiloxane based systems (solvent-containing) exhibited acceptable gloss but low durability. Attempts to increase such durability included incorporation of polyols (U.S. Pat. No. 3,956,174) or silicone resins (U.S. Pat. No. 4,113,677). However, these systems also require organic solvents. Other examples of solvent based systems or aqueous systems with considerable solvent content include those described in U.S. Pat. Nos. 3,960,575; 4,113,677; and U.S. Pat. No. 4,592,934, the latter of which demonstrates the difficulty of successful formulation by providing a two part system with a water-in-oil (invert) emulsion of aminoalkyl-functional siloxane as one component and an oil-in-water polydimethylsiloxane emulsion, which must be kept separate prior to application. Separate storage and mixing are highly disadvantageous. More recently, U.S. Pat. No. 7,753,998 in particular targets tire shine and polymer surface application using a solvent based system or an aqueous dispersion including, as the dispersed phase, aminoalkylsiloxanes, polydimethylsiloxanes, cyclic polysiloxanes, and poly (α-olefins). The aqueous system includes solvent in the dispersed phase, and is thus not solvent free.

In addition to all these systems, innumerable formulations have been developed for hard surfaces, such as stainless steel, marble, granite, wood, and ceramic tile. However, not only is the mode of application completely different, but the surfaces to be treated and the durability and other requirements are completely different as well. Thus, formulations for hard surface cleaning and care have been, in general, inapplicable to tire shine and polymer applications.

Moreover, applications such as tire dressing have unique problems associated with them which are unique to this application, for example, “sling off” Sling off occurs when tire dressing is still fluid after application when the car is driven. Centrifugal forces sling the dressing onto body parts, where they may cause streaking, or prior to driving, may drip or run onto the wheels, which today are typically of light alloy construction. Thus, a fast drying formulation is required. Fast drying can be accomplished by addition of volatile solvents, but as indicated earlier, this is very undesirable. Fast drying aqueous formulations with low sling off have not been available.

The problems and patent references discussed above are a clear indication that there has been a long felt need to provide an aqueous composition useful, e.g., on tires and polymer surfaces, which simultaneously exhibit high gloss, ease of application, good durability, and low sling off. It is also desirable from a consumer standpoint, that the compositions be clear or at least translucent.

For many years now, kitchen appliances such as dishwashers, refrigerators, ovens, and cooktops have featured stainless steel exteriors. This is true, in particular, of so-called “high end” appliances which are favored by discriminating consumers. The “finish” of such appliances can range from a relatively mirror-like, glossy finish to many varieties of matte finishes, including a variety of brushed finishes which have become increasingly popular. The popularity of stainless steel exteriors, however, is diminished by their propensity to stain or become temporarily discolored due to contact with liquids, including greases and oils, and fingerprints as well. Thus, for the majority of consumers, these appliances need frequent cleaning and other attention to remove these stains, and particularly fingerprints or smudges.

Many “stainless steel cleaners” or “polishes” are commercially available. Some of these include relatively harsh ingredients including degreasers, detergents, and the like, while others include oleaginous substances which are designed to provide an aesthetic surface without including chemicals which might otherwise degrade the surface over long term use. Unfortunately, these types of polishes are often even more subject to smudging by contact, for example, with the hands or fingers, than are polishes which do not contain such oily ingredients. It would be desirable to provide a stainless steel polish which is easily applied, provides an aesthetic “polished” surface, and which does not have a propensity to smudging.

### SUMMARY OF THE INVENTION

It has now been surprisingly and unexpectedly discovered that solvent-free aqueous compositions suitable for use, inter alia as tire and polymer surface dressing, and which offer high gloss, low sling off, and good durability, can be prepared by incorporating an acrylate polymer, an organopolysiloxane with “diamino” functionality as hereafter defined, and a wax dispersion, in the form of an aqueous microemulsion. These compositions have also surprisingly and unexpectedly discovered to be highly useful in treating stainless steel surfaces.

### DETAILED DESCRIPTION

The composition of the present invention, hereafter referred to “gloss enhancing compositions,” or “stainless steel polishes,” respectfully, include, as a single dispersed phase or a plurality of phases, a film forming acrylate polymer; a diaminopolysiloxane fluid; and a wax. The compositions, as prepared, are transparent or translucent microemulsions.

The compositions are preferably prepared by simple admixture of emulsions or dispersions of the film forming acrylate polymer, diaminopolysiloxane, and wax.

The diamino organopolysiloxane fluid is an organopolysiloxane bearing “diamino” groups corresponding to the formula

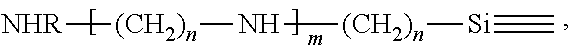

where R is as defined hereafter, m is at least 1 and n is at least 1, and are prepared by reacting an aminoalkylalkoxysilane (“diaminosilane”) as described hereafter, with a silanol-stopped organopolysiloxane.

The silanol-stopped organopolysiloxane preferably corresponds to the formula

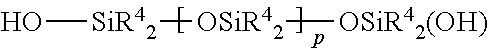

where p is an integer such that the polymer has the viscosity indicated below, where R⁴, independently, is a hydrocarbon radical, preferably C₁₋₁₈ alkyl, C₅₋₆ cycloalkyl, C₆₋₁₀ aryl, or C₈₋₁₂ arylalkyl. R⁴, for purposes of economy, is preferably methyl. However, silanol-stopped organopolysiloxanes bearing phenyl and arylalkyl groups such as phenylethyl groups in addition or in lieu of methyl groups are also preferred. Silanol-stopped branched organopolysiloxanes or silanol-stopped organopolysiloxanes also containing chain-pendant silicon-bonded hydroxyl groups may also be used, but are not preferred. Intentionally, or as an artifact of their preparation, the silanol-stopped organopolysiloxanes may contain Si-bonded, preferably lower alkoxy groups such as methoxy or ethoxy groups, in place of R⁴.

The silanol-stopped organopolysiloxane preferably has a viscosity of from 20 to 5000 mPas, preferably 30 to 2500 mPas, and most preferably from 40 to 200 mPas. The mol ratio of diaminosilane to silanol-stopped organopolysiloxane will determine both the final molecular weight of the product as well as whether there are only terminal “diamino” groups (e.g. at one or two termini) or also pendant diamino groups. At least one such group must be present. The final product should preferably have a neat viscosity of 400 mPas to 15,000 mPas, more preferably 1000 mPas to 10,000 mPas, and an amine number of 2.5 to 20 mgKOH/g. A suitable fluid is available commercially from Wacker Chemical Corporation, Adrian, Mich., as polymer WR 1100, having a viscosity of 3000-8000 cst with an average amine number of 7.3-8.4 mgKOH/g.

The aminoalkylalkoxysilane which is reacted with the silanol-stopped organopolysiloxane is a silane containing both lower alkoxy and aminoalkyl-functionality. The aminoalkylalkoxysilane may also contain hydrocarbon molecules and long-chain alkoxy groups. The aminoalkylalkoxysilane or “diaminosilane” preferably corresponds to those of the formula

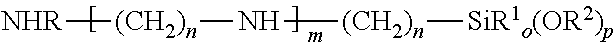

where R is hydrogen or a hydrocarbon radical, preferably C₁₋₁₈ alkyl, R¹ is a hydrocarbon radical, preferably C₁₋₁₈ alkyl, cycloalkyl, cycloalkylalkyl, aryl, or arylalkyl, preferably C₁₋₆ alkyl or C₆₋₁₀ aryl, and more preferably C₁₋₄ alkyl, most preferably methyl; and R² is C₁₋₁₈ alkyl or cycloalkyl, more preferably C₁₋₆ alkyl, and most preferably methyl or ethyl, with the proviso that at least one R² is methyl or ethyl; m is 0 to 10, more preferably 0 to 4, and most preferably 1 or 2; n is at least one and preferably 2-6, more preferably 2-4 and most preferably 2 or 3; o is 0, 1, or 2 and p is 1, 2, or 3, with the proviso that o+p=3, wherein p is preferably 2 or 3, more preferably 2. By “hydrolysate thereof” is meant a hydrolysis product containing fewer OR² groups than the unhydrolyzed silane. Such hydrolysates may be formed prior to reaction with the silanol-stopped organopolysiloxanes. Use of partial hydrolysates is not preferred.

More preferably, the aminoalkyl groups of the aminoalkylalkoxysilane are 3-aminopropyl-2-aminoethyl, or 2-aminoethyl-3-aminopropyl groups. More preferably, the alkoxy groups are methoxy or ethoxy groups. More preferably, for reasons of economy, the R¹ groups of the aminoalkyalkoxysilanes are methyl groups. More preferably, p is 2. Thus, the most preferred aminoalkylalkoxysilanes are N-(2-aminoethyl)-3-aminopropylmethyldimethoxysilane and N-(3-aminopropyl)-2-aminoethylmethyldimethoxysilane.

Mixtures of various aminoalkylalkoxysilanes are also useful. For example, “monoaminosilanes” such as aminopropylmethyldimethoxysilane and 3-aminopropyltrimethoxysilane may be used in conjunction with the diaminosilanes. Preferred mixtures contain one of the most preferred aminoalkylalkoxysilanes mentioned above. Also, other alkoxysilanes may be included, for example those of the formula

R³ₐSi(OR²)₄₋ₐ

where R³ is a hydrocarbon radical, preferably C₁₋₁₈ alkyl or C₅₋₆ cycloalkyl, or aryl, more preferably C₁₋₄ alkyl, and most preferably C₁₋₃ alkyl; R² is defined as above, and a is 0, 1, 2, or 3.

Hydrolysates of these, in particular partial hydrolysates, alone or in admixture with the aminoalkylalkoxysilanes or hydrolysate products thereof may also be used, but this is not preferred.

The diamino organopolysiloxanes may thus also contain ordinary silicon-bonded aminoalkyl groups in addition to the diamino groups, but this is not preferred. If the resulting product of the reaction between the aminoalkylalkoxysilane and the silanol-stopped fluid is too highly branched, or contains too many unreacted alkoxy groups, the final gloss-enhancing composition may not be stable. This instability can generally be noted immediately. For example, when only N-(2-aminoethyl)-3-aminopropyltrimethoxysilane is reacted with a disilanol stopped fluid, an emulsion of this diamino organopolysiloxane, when mixed with the other ingredients of the formulation, produced a product with a consistency similar to cottage cheese. It is believed that the high number of alkoxy groups in the aminoalkylalkoxysilane, coupled with the amount used, created this effect, which may not be the case with different silanes and/or different mol ratios. Regardless, selection of a particular reaction product of aminoalkylalkoxy silane and silanol-stopped fluid is straight forward and does not involve undue experimentation, since both the synthesis of this component as well as its compounding with other ingredients is neither arduous nor time consuming.

The film forming acrylate polymers are polymers of alkylacrylates which may further include residues of other polymerizable comonomers such as olefins, dienes, ethylenically unsaturated aryl compounds such as styrene and α-methylstyrene, vinyl chloride, acrylonitrile, (meth)acrylamide, and in particular, unsaturated carboxylic acids such as acrylic acid, methacrylic acid, crotonic acid, etc.; hydroxyalkylacrylates and methacrylates, fumaric acid, etc.

Preferably, the film forming polyacrylate polymer includes monomer units with anionic functionality, water insoluble monomer units, and optionally water soluble monomer units. The film forming polyacrylate preferably contains carboxylate salt units where the cationic counterion is selected from the alkali metals, preferably sodium or potassium, or ammonium. The molecular weight is not critical, but preferably ranges from 1000 Daltons to about 100,000 Daltons. A preferred polyacrylate polymer comprises units derived from methacrylic acid, styrene, ethylacrylate, methylmethacrylate, and 2-hydroxyethylmethacrylate. A preferred film-forming polyacrylate polymer is SYNTRAN® 1560, available from Interpolymer Corporation as a 25 weight percent emulsion with a pH of 7.2.

The particular acrylate polymer used must be compatible with the diaminosiloxane and any other reactive components. In this context, “compatible” means that upon admixture of the components, no gelling, coagulation, or phase separation should occur, and the resulting composition should be storage stable with respect to these qualities, for a period of at least one month when stored at 50° C. and stable for at least 9 months at 25° C.

Stability from gelling, coagulation, and phase separation can be assessed visually, by the unaided eye. It has been found that the pH of the acrylate polymer emulsion may have an effect on stability and the pH should preferably be higher than 6.0, more preferably higher than 7.0. High alkalinity is not desired, and thus the acrylate polymer dispersion should preferably have a pH of less than 9.5, more preferably less than 9, yet more preferably less than 8.5, and most preferably less than 8. The pH may be adjusted during acrylate polymer synthesis by varying the amount of acid monomers such as acrylic acid and methacrylic acid, or by using salts of the acid monomers, and may be adjusted following synthesis, by partial or complete neutralization by addition of a base such as sodium hydroxide, potassium hydroxide, or ammonia.

Polyacrylate film forming polymers with no water soluble groups are not preferred.

The wax component may be any wax available or preparable as a microemulsion, and thus both natural waxes such as montan wax, carnauba wax, paraffin wax, and the like may be used, as well as synthetic waxes which are generally oligomeric to low polymeric polyolefin polymers, for example polyethylene waxes. Such wax emulsions are readily available commercially. A preferred wax emulsion is Poly Emulsion 325G available from BYK.

The proportions of (A) diaminopolysiloxane emulsion, (B) film forming polyacrylate polymer dispersion, and (C) wax emulsion, can vary over a wide range in the gloss enhancing compositions, but the ratio of A:B:C is preferably from 0.2-2:1-3:1-2, more preferably 0.2-1.5:1-2:1-1.5, and most preferably 0.5:1.5:1. These ratios are based on solids ingredient content of 50% (A), 25% (B) and 35% (C), and may be readily recalculated based on different solids contents. The total solids content of the composition is preferably from 20 to 60% by weight, more preferably 30 to 50%, and most preferably 31 to 37%.

The weight percentages of individual ingredients as well as total solids content are merely a guide to formulating, and not critical, unless otherwise noted. Ratios outside those disclosed above may be useful in forming an acceptable composition, and are also within the scope of the invention, as long as the composition contains all of (A), (B), and (C), increases gloss when applied to a polymer surface, is storage stable, and free from flaking The compositions are also preferably durable and exhibit low sling off.

The inventive formulations may also contain further ingredients so long as a storage stable and gloss-enhancing composition is obtained. Examples of further ingredients include, but are not limited to, organopolysiloxanes, particularly polydimethylsiloxanes; silicone resins such as MQ, MDQ, MT, and T resins, particularly methyl substituted; aminoalkylalkoxysilanes and alkylalkoxysilanes; plasticizers such as alkylphthalates, trialkylphosphates, alkyladipates, etc; biocides; fragrances; minor amounts of coalescing agents such as diethylene glycol monomethyl ether and diethylene glycol monopropyl ether; antioxidants such as BHT, etc., UV absorbants, etc. Surfactants are necessary to facilitate storage stability. Such surfactants are generally already included in the emulsions used to prepare the composition. For example, SYNTRON 1560 is believed to contain about 1 weight percent sodium alkyl polyethoxyethanolsulfosuccinate, about 1 weight percent sodium laurylsulfate, and about 1 weight percent of sodium laurylpolyethoxyethanol. Additional surfactants may be added however, and will be necessary if neat ingredients are used to prepare the aqueous emulsion.

For the purpose of the invention it is possible to use as emulsifiers, any suitable ionic or nonionic emulsifier, individually and in the form of mixtures of different emulsifiers, with which it is possible to prepare aqueous dispersions, especially aqueous emulsions of organopolysiloxanes, waxes, and acrylate polymers.

Examples of anionic emulsifiers are as follows:

1. Alkyl sulfates, particularly those having a chain length of 8 to 18 carbon atoms, alkyl and alkaryl ether sulfates having 8 to 18 carbon atoms in the hydrophobic radical and 1 to 40 ethylene oxide (EO) and/or propylene oxide (PO) units.

2. Sulfonates, particularly alkylsulfonates having 8 to 18 carbon atoms, alkylarylsulfonates having 8 to 18 carbon atoms, taurides, esters, including monoesters, of sulfosuccinic acid with monohydric alcohols or alkylphenols having from 4 to 15 carbon atoms; if desired, these alcohols or alkylphenols may also have been ethoxylated with 1 to 40 EO units.

3. Alkali metal salts and ammonium salts of carboxylic acids having 8 to 20 carbon atoms in the alkyl, aryl, alkaryl or aralkyl radical.

4. Phosphoric acid partial esters and their alkali metal salts and ammonium salts, particularly alkyl and alkaryl phosphates having 8 to 20 carbon atoms in the organic radical, alkyl ether phosphates and alkylaryl ether phosphates having 8 to 20 carbon atoms in the alkyl or alkaryl radical and 1 to 40 EO units.

Examples of nonionic emulsifiers are as follows:

5. Polyvinyl alcohol still containing 5% to 50%, preferably 8% to 20%, of vinyl acetate units, with a degree of polymerization of 500 to 3000.

6. Alkyl polyglycol ethers, preferably those having 3 to 40 EO units and alkyl radicals of 8 to 20 carbon atoms.

7. Alkylaryl polyglycol ethers, preferably those having 5 to 40 EO units and 8 to 20 carbon atoms in the alkyl and aryl radicals.

8. Ethylene oxide/propylene oxide (EO/PO) block copolymers, preferably those having 8 to 40 EO/PO units.

9. Adducts of alkylamines having alkyl radicals of 8 to 22 carbon atoms with ethylene oxide or propylene oxide.

10. Fatty acids having 6 to 24 carbon atoms.

11. Alkylpolyglycosides of the general formula R*—O—Zₒ, in which R* is a linear or branched, saturated or unsaturated alkyl radical having on average 8-24 carbon atoms and Zₒ is an oligoglycoside residue containing on average o=1-10 hexose or pentose units or mixtures thereof.

12. Natural substances and derivatives thereof, such as lecithin, lanolin, saponins, cellulose; cellulose alkyl ethers and carboxyalkylcelluloses whose alkyl groups each possess up to 4 carbon atoms.

13. Linear organo(poly)siloxane-containing polar groups containing in particular the elements O, N, C, S, P, Si especially those having alkoxy groups with up to 24 carbon atoms and/or up to 40 EO and/or PO groups.

Examples of cationic emulsifiers are as follows:

14. Salts of primary, secondary, and tertiary fatty amines having 8 to 24 carbon atoms with acetic acid, sulfuric acid, hydrochloric acid, and phosphoric acids.

15. Quaternary alkylammonium and alkylbenzeneammonium salts, especially those whose alkyl groups possess 6 to 24 carbon atoms, particularly the halides, sulfates, phosphates, and acetates.

16. Alkylpyridinium, alkylimidazolinium, and alkyloxazolinium salts, especially those whose alkyl chain possesses up to 18 carbon atoms, particularly the halides, sulfates, phosphates, and acetates.

Particularly suitable ampholytic emulsifiers include the following:

17. Amino acids with long-chain substitution, such as N-alkyl-di(aminoethyl)glycine or N-alkyl-2-aminopropionic salts.

18. Betaines, such as N-(3-acylamidopropyl)-N,N-dimethylammonium salts having a C₈-C₁₈ acyl radical, and alkylimidazolium betaines.

Preferred emulsifiers are nonionic emulsifiers, especially the alkyl polyglycol ethers listed above under 6.

The surfactant may comprise one of the abovementioned emulsifiers or of a mixture of two or more abovementioned emulsifiers, and may be used in pure form or as solutions of one or more emulsifiers in water or organic solvents.

Organic solvents are preferably absent, although it would not depart from the spirit of the invention to include a minor amount of organic solvent, i.e., less than 5 weight percent based on the total weight of the formulation, more preferably less than 2 weight percent, and yet more preferably, less than 1 weight percent. In the context of the invention, organic solvents do not include glycol ether coalescing agents, but if both are present, the amounts should be less than 10 weight percent, more preferably less than 5 weight percent. When organic solvents are present, it is preferred that they be environmentally acceptable, and most preferably have a low ozone depletion potential. Preferred organic solvents, when used, include methanol, ethanol, lower hydrocarbons such as pentane or hexane, and in particular, tertiarybutylacetate. Preferably, no coalescing agents and no organic solvents are present. By “substantially absent” or “substantially free of” relative to organic solvents is meant that the organic solvent is present in less than 2% by weight.

For stainless steel polish formulations, the preferred ratios of the A are somewhat different than is the case for the gloss enhancing compositions, B, and C components. In this case, the preferred ranges A:B:C: are: 0.2-2:0.1-3:0.5-2.

The stainless steel polish formulations may be applied in a conventional manner, e.g. from a spray can, pump spray container, or on a polishing cloth such as ordinary terrycloth. After application and gentle buffing to assure a uniform distribution, and removal of existing stains and fingerprints, the coating dries to a solid which is resistant to further smudging. Even more surprising, when fingerprints or other smudges do appear, they can be removed by cleaning with a dry paper towel or dry cloth towel, without application of further polish.

The ingredients (A), (B), and (C) are preferably supplied as previously formed emulsions/dispersions, and are simply mixed together by stirring. Any conventional stirring apparatus may be used. The order of mixing is not critical, but more transparent compositions with higher long term stability were generally created by adding the film forming polyacrylate dispersion to the wax dispersion, followed by addition of the silicon-containing component. Some of the compositions did turn more opalescent (“hazy”) upon long term storage, but were not opaque. The haze did not affect the performance.

Sample Preparation

All samples are applied and tested on 6″ square pieces of Montana SL-5900 Harbor Blue Vinyl. A 0.3 cm² sample of formulation is spread onto the vinyl using a 4″ square piece of cotton diaper. The coated vinyl is then dried in a forced air over for 10 minutes at 55° C. Gloss is recorded as the average of a minimum of 5 readings at the 85° setting of a Hunter Lab Pro Gloss 3 gloss meter. A reading designated as blank is taken on untreated vinyl and the change in gloss is reported as the gloss effect. A positive number is an indication of gloss enhancement and negative being a detraction from the gloss of the blank uncoated vinyl.

Smear Testing

Smear testing is evaluated by running a finger across the treated area onto an untreated area of vinyl. If material transfer is noted then coating is designated as wet. Positive results mean a wet coating and transferability of finish while negative notes a dry coating and non-transferability.

Rain Durability Testing

Rain durability testing is done on a spray test machine designed internally with a regulator to control pressure and time of the spray. The samples are sprayed at the noted psi, for the noted time, from a nozzle set 6″ above the test vinyl which is placed at a 45° angle below the nozzle. Excess water is patted off the surface with care to not smear the coating and then the panels are dried in forced air over for 10 minutes at 55° C. before 85° gloss is measured “post rain”. Notation of gloss loss (negative number) or increase (positive) indicates a percentage change from the initial gloss enhancement.

Having generally described this invention, a further understanding can be obtained by reference to certain specific examples which are provided herein for purposes of illustration only and are not intended to be limiting unless otherwise specified.

Silicone emulsion A is a 20 weight percent solids emulsion of a bis-[N-(2-aminoethyl)-3-aminopropyl] terminated polydimethyl siloxane having a base equivalent weight of 0.0387 meg/g, stabilized with 1.02% of alcohol ethoxylate, 2.26% isotridecanolethoxylate, and 0.22% ethoxylated alcohol.

Acrylic dispersion B is SYNTRAN© 1560, a surfactant-stabilized emulsion containing 40 weight percent of polymer, 0.4 weight percent of each of sodium alkylpolyoxyethanol sulfosuccinate, sodium lauryl sulfate, and sodium laurylpolyoxyethanol sulfate.

Wax emulsion C is a 40% by weight solids wax emulsion, Chemcor 325G, containing about 4 weight percent of 12-15 primary alcohol ethoxylate as a surfactant.

### COMPARATIVE EXAMPLE C1

Acrylic Dispersion B is applied to vinyl per sample preparation protocol. The coating is a white and flaky coating. No durability testing is done.

### COMPARATIVE EXAMPLE C2

Silicone Emulsion A is applied to vinyl per sample preparation protocol. Coating is wet and smear test is positive with high transferability noted. Initial gloss enhancement units were 15.2 Gloss loss after 10 minutes at 3 psi was −81%.

### COMPARATIVE EXAMPLE C3

Wax Emulsion C is applied to vinyl per sample preparation protocol. The coating will not wet out the full surface and is blotchy as areas are left uncoated and others coated. It does result in a dry coating with a negative smear characteristic. Initial gloss enhancement units are 10.2. Gloss loss after 10 minutes at 3 psi was −42%.

### COMPARATIVE EXAMPLE C4

Wax Emulsion C and Acrylic Dispersion B were mixed at a 1:1 weight percent ratio and then applied to vinyl per sample preparation protocol. The coating was dry and showed negative smear characteristics. Initial gloss enhancement units were 11.2. Wetting across the surface was not good and gloss loss after 60 minutes at 10 psi pressure was −42%.

### COMPARATIVE EXAMPLE C5

Wax Emulsion C and Silicone Emulsion A were mixed at a 1:1 weight percent ratio and then applied to vinyl per sample preparation protocol. Initial gloss enhancement units were 14.0 but resulted in a whitish coating that was tacky to the touch and demonstrated positive smear characteristics. The coating never dried to the desired dry state. No rain durability tested.

### COMPARATIVE EXAMPLE C6

Silicone Emulsion A and Acrylic Dispersion B were mixed at a 1:1 weight percent ratio. The sample separated into two phases with partial semi-curing of a layer noted. Material could not be coated on vinyl matrix.

### EXAMPLE 1

Wax Emulsion C, and Acrylic Dispersion B, and Silicone Emulsion A were mixed at a 1:1:1 weight percent ratio and then applied to vinyl per sample preparation protocol. Coating was dry and showed negative smear characteristics. Initial gloss enhancement units were 13.4. Wetting across the surface was not optimal, but gloss loss after 60 minutes at 10 psi pressure was −8.9%.

### EXAMPLE 2

Wax Emulsion C, Acrylic Dispersion B, and Silicone Emulsion A were mixed at a 1:1:0.5 weight percent ratio and then applied to vinyl per sample preparation protocol. Coating was dry and showed negative smear characteristics. Initial gloss enhancement units were 16.3. Gloss loss after 60 minutes at 10 psi pressure was −9.8%.

### EXAMPLE 3

Wax Emulsion C, Acrylic Dispersion B and Silicone Emulsion A were mixed at a 1:1:2 weight percent ratio and then applied to vinyl per sample preparation protocol. Coating was dry and showed negative smear characteristics. Initial gloss enhancement units were 17.1. Film developed a white haze to it and rain testing was not done.

### EXAMPLE 10

Wax Emulsion C, Acrylic Dispersion B and Silicone Emulsion A were mixed at a 1:1:.5 weight percent ratio and then applied to vinyl per sample preparation protocol. Coating was dry and showed negative smear characteristics. Initial gloss enhancement units were 15.7. Gloss loss after 15 minutes at 10 psi pressure was 8.9%.

### COMPARATIVE EXAMPLE C7

### Solvent Based Product

Vinyl was coated with a commercial, solvent based formulation per the sample preparation protocol. Initial gloss enhancement units were 17.8. Coating developed positive smear characteristics and high sling off potential. Gloss loss after 30 minutes at 10 psi pressure was −84.8%.

### COMPARATIVE EXAMPLE C8

### Solvent Based Product

Vinyl was coated with another commercial solvent-based formulation per the sample preparation protocol. Initial gloss enhancement units were 24.8. Coating developed positive smear characteristics and high sling off potential. Gloss loss after 30 minutes at 10 psi pressure was −92%.

### COMPARATIVE EXAMPLE C9

### Solvent Based Product

Vinyl was coated with a yet further commercial, solvent-based formulation per the sample preparation protocol. Initial gloss enhancement units were 12.3. Coating demonstrated positive smear characteristics and potential for high sling-off. Gloss loss after sitting in ambient conditions for 1 hour-70%. No rain testing could be done.

### COMPARATIVE EXAMPLE C10

### Water Based Product

Vinyl was coated with a commercial water-based formulation per the sample preparation protocol. Initial gloss enhancement units were 7.0. Coating was dry and showed negative smear characteristics. Gloss loss after 15 minutes at 10 psi pressure was −90%.

In Comparative Examples C1-C6, individual components or mixtures of components not containing all of (A), (B), and (C) showed serious deficiencies, as noted. Only when all of (A), (B), and (C) were used together were coatings obtained which dry rapidly, do not flake, provide high gloss, and high durability. In Comparative Examples C7-C10, the commercially available solvent based systems were capable of producing high gloss, but had high smear potential, very low durability, and of course contained considerable undesirable organic solvent. The commercial water-based product produced low gloss, but had good drying and smear characteristics. However, it had very low durability.

### EXAMPLE 11

An aqueous stainless steel polish formulation is prepared by adding 13.51 parts of silicone emulsion A, 5.41 parts of acrylic dispersion B, and 27.03 parts of wax dispersion C to 54.05 parts water. A stable microemulsion resulted. This composition is applied to a dry terrycloth towel and applied to a brushed stainless steel surface. The surface achieves a pleasant, darkened polish effect, which is resistant to fingerprinting and smudging by incidental contact.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An aqueous stainless steel polish composition, comprising an aqueous emulsion of
A) at least one diaminopolysiloxane;
B) at least one film forming polyacrylate polymer; and
C) wax.

2. The stainless steel polish composition of claim 1, wherein the diaminopolysiloxane contains silicon-bonded diamino groups of the formula 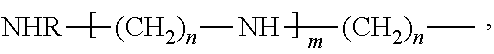
where m is at least 1 and n is at least 1, R is a hydrocarbon radical or hydrogen.

3. The stainless steel polish composition of claim 1, wherein the polyacrylate polymer contains residues of an unsaturated aliphatic carboxylic acid and has a pH greater than 6.

4. The stainless steel polish composition of claim 1, wherein the diaminopolysiloxane is a reaction product of reactants comprising at least one amino alkylalkoxysilane of the formula 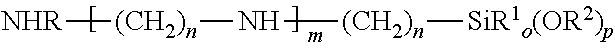
where R is a hydrogen or hydrocarbon radical, m is 0 to 10, n is at least one, R¹ is a hydrocarbon radical, R² is C₁₋₁₈ alkyl or cycloalkyl, and p is 1, 2, or 3, with the proviso that o+p=3, with a silanol-stopped polydiorganosilxoane having a viscosity of from 200 to 5,000 mPa·s.

5. The stainless steel polish composition of claim 1, wherein the weight ratio of (A):(B):(C) is from 0.2-2:0.1-3:0.5-2, based on A, B, and C in the form of aqueous emulsions or dispersions, with solids contents of 50 weight percent, 25 weight percent, and 35 weight percent, respectively.

6. The stainless steel polish composition of claim 1, which is substantially free of organic solvent.

7. The stainless steel polish of claim 1, which is free of organic solvent.

8. The stainless steel polish of claim 1, wherein the diaminopolysiloxane has a neat viscosity at 25° C. of 400 mPas to 15,000 mPas.

9. The stainless steel polish on of claim 1, where the aqueous emulsion is transparent or translucent.

10. A method for the preparation of a gloss enhancing composition of claim 1, comprising emulsifying components A), B), and C) into an aqueous phase.

11. A method for the preparation of a gloss enhancing formulation of claim 1, comprising providing aqueous emulsions of A), B), and C), and mixing the aqueous emulsions together.

12. A process for polishing a stainless steel surface, comprising applying to the stainless steel surface a stainless steel polish composition of claim 1.

13. A process for polishing a stainless steel surface, comprising applying to the stainless steel surface a stainless steel polish composition of claim 2.

14. A process for polishing a stainless steel surface, comprising applying to the stainless steel surface a stainless steel polish composition of claim 3.

15. A process for polishing a stainless steel surface, comprising applying to the stainless steel surface a stainless steel polish composition of claim 4.

16. A process for polishing a stainless steel surface, comprising applying to the stainless steel surface a stainless steel polish composition of claim 5.

17. A process for polishing a stainless steel surface, comprising applying to the stainless steel surface a stainless steel polish composition of claim 6.

18. A process for polishing a stainless steel surface, comprising applying to the stainless steel surface a stainless steel polish composition of claim 7.

19. A process for polishing a stainless steel surface, comprising applying to the stainless steel surface a stainless steel polish composition of claim 8.

20. The process of claim 12, wherein the stainless steel polish which is applied to the surface dries to form a smudge-resistant coating.
